(19) United States
(12) Patent Application Publication
(10) Pub. No.: US 2012/0290437 A1
(43) Pub. Date: Nov. 15, 2012

(54) System and Method of Selecting and Acquiring Still Images from Video

(76) Inventors: David Aaron Hibbard, West Hollywood, CA (US); Micah Gabriel Katz, Atlanta, GA (US); Mathew Nicholas Matelan, Glendale, CA (US)

(21) Appl. No.: 13/469,993

(22) Filed: May 11, 2012

Related U.S. Application Data
(60) Provisional application No. 61/485,584, filed on May 12, 2011.

(51) Int. Cl. G06Q 30/06; G06Q 20/02; G06F 3/00

(52) U.S. Cl. 705/26.41; 715/719

(57) ABSTRACT

The present invention provides a system and process whereby a library of video files is created, and a user may select one or more video files to examine from the library of available files, identify one or more individual frames from the selected video files, optionally manipulate and transform one or more frames to create a customized image, optionally purchase a product incorporating the image, and transmit or send the customized image along with any order information for physical or electronic fulfillment options including, but not limited to, printing, e-mailing, sharing on a social network or other website, or otherwise reproducing.

### CROSS REFERENCE TO RELATED APPLICATIONS

This application relates to and claims priority from U.S. Prov. App. No. 61/485,584, filed on May 12, 2011, the contents of which are fully incorporated herein by reference.

### FIELD OF THE INVENTION

The present invention provides a system and process whereby a library of video files is created, and a user may select one or more video files to examine from the library of available files, identify one or more individual frames from the selected video files, optionally manipulate and transform one or more frames to create a customized image, optionally purchase a product incorporating the image, and transmit or send the customized image along with any order information for physical or electronic fulfillment options including, but not limited to, printing, e-mailing, sharing on a social network or other website, or otherwise reproducing.

### BACKGROUND OF THE INVENTION

A vast catalogue of video files of movies, music videos, and special events (such as concerts or athletic events) that have been recorded is currently available in various digital formats. Also, people are making extensive use of video cameras, including those embedded in cellphones or other hand-held devices, to record their own video files. These files contain millions or billions of still images, generally compressed via well-known compression techniques. Compression of video files commonly involves storing some individual frames of the video as images (called “i-frames” or “key frames”) that contain all the data for that particular frame, and other frames as encoded information that enables reconstructing those frames from their differences relative to the neighboring frames (“p-frames” or “b-frames”). This compression and decompression is frequently accomplished with specialized hardware and/or software.

These video files comprise intellectual property of substantial value, and are of significant interest to a large segment of the public. Increasing numbers of these files are stored as high definition (HD) video files, generally meaning that images therein have display resolutions of at least 1,280 by 720 pixels (720p) or 1,920 by 1,080 pixels (1080i or 1080p). Although a few images may have been selected from those files and marketed by the content providers, for example as posters or t-shirts, viewers have not been able to select their own favorite images or manipulate those images to customize them and make them their own. There is a large market for such images as posters, canvas prints, photo prints, electronic images, and a wide variety of other merchandise.

In addition, users are increasingly making their own digital video files of events that they find significant. They cannot easily, however, select images from those files to make and share their own personal posters, canvas prints, t-shirts, or similar merchandise.

There are several problems with providing user access to and online manipulation of high quality (HQ) video files, wherein high quality files include HD files and other files possibly of lower display resolution than 1280 pixels by 720 pixels, but still requiring high bit rates for streaming to the viewer. One problem is that, because of the size of the files and the high bitrate necessary to transfer them, the transfer of high quality video files consumes significant bandwidth, which can result in excessive costs and unsatisfactory performance for both the supplier and the consumer of those files. Another problem is that owners of the files are reluctant to make large segments of these high quality files available over the Internet, since such actions can expose the files to possible piracy. Finally, operations on large high quality files performed on clients' platforms can consume substantial resources, resulting in unsatisfactory performance for an unprofessional user. Many laptop computers or handheld devices lack the performance features necessary to successfully play or edit high quality videos. However, lower quality images cannot reliably provide the resolution needed for such uses as large-scale printing without visible pixelation. Capture of a high quality image from a video is thus a desirable capability not currently realized.

To date, there has not been an effective and seamless way for Internet users to identify and capture an image from high quality video files that retains the resolution available in the original files, to manipulate that image to create a large, high-definition, customized version of their desired image, or to complete the desired disposition of the customized image. While various combinations of hardware and software can be used to ‘grab,’ or ‘capture’ individual frames from within motion pictures and video, currently available tools require the user to separately bring to completion any desired use for such a captured image, including printing or sharing. Moreover, a user capturing an image from a playing video will not generally have access to the resolution of the underlying media file and will be left with only the image as it was displayed on the user's monitor. Even if users are able to ‘grab’ an image directly from the underlying media file, they may lose crucial resolution during the editing process as they perform operations to modify, reproduce, or copy the image.

Therefore, a need exists for a system and process whereby a library of readily playable video files may be created that corresponds to higher quality video files; one or a set of files may be selected from the library and viewed; one or more individual frames may be selected from the video file and optionally manipulated and customized by the viewer; the corresponding high quality images or frames from the corresponding higher quality stored video or motion picture file may be identified and correspondingly manipulated and customized; and the resulting customized selected high quality image may be transmitted or sent for physical or electronic fulfillment options including, but not limited to, printing, e-mailing, hosting or otherwise reproducing. Implementing such a system via an Internet connection can provide access to an extensive collection of files without requiring large capacity or high performance user devices. A system and method according to invention principles addresses these deficiencies and related problems.

### SUMMARY OF THE INVENTION

A system and method whereby a library of high quality and corresponding lower quality video files is created; one or a set of video files is selected from the lower quality library and viewed by a user; one or more individual frames are selected from the selected file by the user; said images or frames are optionally manipulated and customized in various ways by the user to create a resulting image; the corresponding high quality frames from the corresponding stored video clip are identified and correspondingly manipulated and customized to create a resulting image; optionally, a product incorporating the image is selected and ordered from a catalogue of available products; and such resulting high quality image and associated order information are transmitted or sent for physical or electronic fulfillment options including, but not limited to, printing, e-mailing, sharing, hosting, posting or sharing to a website, or otherwise reproducing.

### BRIEF DESCRIPTION OF THE DRAWINGS

FIG. 1 illustrates a functional block diagram of one embodiment of a system for image capture and manipulation and fulfillment of desired processing of the image to produce an electronic or material product;

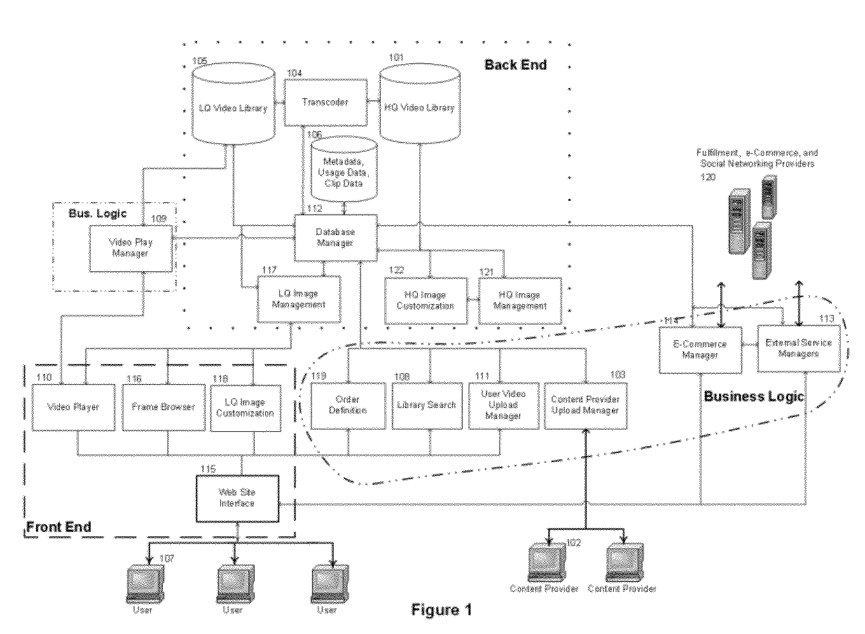

FIG. 2 shows a logical flowchart of a procedure for image capture and manipulation and fulfillment of desired processing of the image to produce an electronic or material product according to invention principles.

FIG. 3 shows a logical flowchart of a procedure for identifying and providing a high quality image according to invention principles.

FIG. 4 shows a functional block diagram of one embodiment of an Image Reviewer Subsystem that is an optional part of the system.

FIG. 5 shows a logical flowchart of a procedure for a reviewer analyzing and editing an image according to invention principles.

FIG. 6 shows an example of a display enabling the selection of a particular frame from a cover flow representation of adjacent frames.

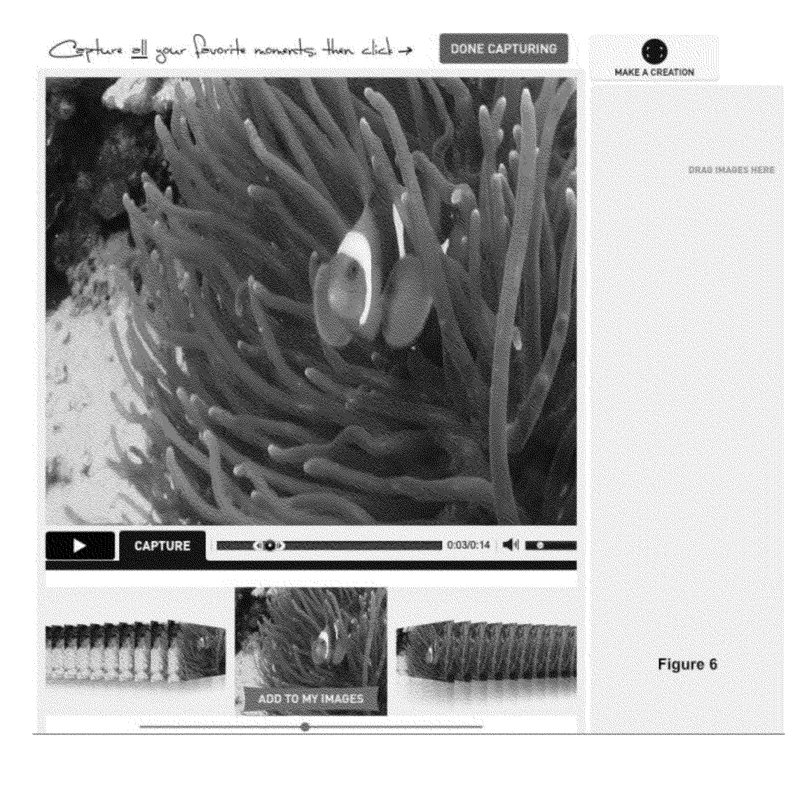

### DETAILED DESCRIPTION OF THE INVENTION

In one embodiment, the system may be organized as a three-tiered structure: a front end user interface, business logic, and back end persisted data. The system may be partitioned and assigned to servers based on the services each partition is to provide. Typically, streaming servers or progressive downloading servers, for example, may be employed for presenting the videos. Alternative embodiments of the system may employ different structurings of the system's essential features.

The system may comprise an HQ Video Library 101 of persisted data in the system backend, created from video files uploaded from Content Providers 102 under control of a Content Provider Upload Manager 103. The HQ Video Library 101 may contain files that have been processed by Transcoder 104 in ways that facilitate seeking smoothly and rapidly through the files. The original versions of these files may have been High Definition video files, or may have been lower definition video files provided by users or from other sources. In one embodiment, each video file may be decoded, key frames may be inserted into the video file at regular small intervals (e.g., every 10 frames), and the frame rate of the video may be adjusted to a standard value (for example, 30 frames per second) before re-encoding the video file in a common file format and separating it into short segments of a standard length (such as twenty-second segments). Such a single edit of the provided video files results in minimal loss of information, while enabling consistent and reliable seeking, search, selection, and manipulation of the processed file. The processed files are thereafter referred to as High Quality (HQ) files. In one embodiment, the h264 file compression standard may be employed for all HQ files, but other file compression standards may also or alternatively be employed. The Database Manager 112 may manage storage of and access to files in the HQ Video Library 101.

In one embodiment, the system may also use the Transcoder 104 to transcode the original video to produce a corresponding LQ version, the LQ Video Library 105, using the same coding parameters as were used in processing the HQ files, (except for the HQ resolution parameters and a standard bitrate) to guide the process. Such transcoding facilitates seeking and scrolling smoothly and rapidly through the files, and also facilitates identification and matching of corresponding images in the HQ and LQ files. In one embodiment, the frame rate, duration, and aspect ratio for the LQ video files may be set to be identical to those of the processed HQ video files with which they are matched; although if the original video file had pixel width inconvenient for display, the resolution of the LQ files may be set to a different width with the image aspect ratio unchanged. In one embodiment, any associated audio component of the original files may be preserved in the resulting LQ video files. In one embodiment, the FLV file format may be employed for LQ files; but other file formats may also or alternatively be employed. The Database Manager 112 may also manage storage of and access to files in the LQ Video Library 105.

In one embodiment, the video files in the database may be metatagged during uploads or later processing to facilitate categorization and searching, producing Metadata Database 106. In one embodiment, registered users may also upload their own videos via the User Video Upload Manager 111 to become persisted data. Users may also tag scenes or individual frames in videos and mark and save specific positions in selected videos, adding additional information to the Metadata Database 106 through the Database Manager 112.

The business logic may manage use of data objects, including user data, video metadata, and metatags. The Metadata Database 106 may be used by the Library Search 108 to facilitate searching for various types or classifications of videos. In one embodiment, the system may support full text search on file descriptions through the Library Search 108. The system may also handle various types of sharing functionality, including linking and interacting with external systems 120 (including such sites as Social Network Providers or Fulfillment Providers offering specialized printing services) through the External Service Manager 113. It may also manage connection and interaction with payment processors through the E-Commerce Manager 114.

In one embodiment, the Web user interaction server may be a front end that is used to deliver the interface application to users on their computers through the Web Site Interface 115. Alternative embodiments may support user access through other computing devices, such as smartphones, tablets, or other handheld devices that can provide necessary functionality and access to the Internet. After searching and identifying a video of interest, a User Client Computer 107 may request play of a particular video through the Video Play Manager 109. The Video Play Manager 109 may submit the LQ video to the Video Player 110 for streaming to the user.

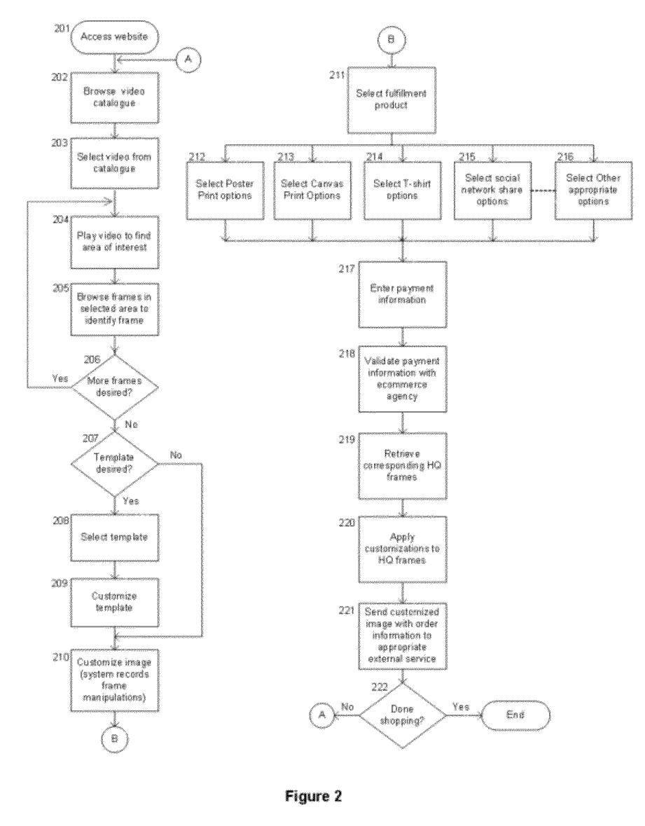

As shown in FIG. 2, the typical course of usage may be that the user accesses the site provided via the Internet 201 and may review the available LQ videos from the catalogue 202. The user may first encounter the Home Screen of the site, which may offer a featured video or highlight special offers. In alternative embodiments, users may access the system through native applications, for example through mobile device operating systems, or through a link from a third-party website rather than via a Home Screen. Using any of various available search affordances, such as title searches, browsing various classifications, and full text search of associated video file descriptions, the user may select a particular LQ video file for further examination 203. The user may play the LQ version of the selected video file 204, viewing and scrubbing the file to identify images of interest, by using the Video Player 110. In one embodiment, associated concurrent audio may play and be controlled by the user as he plays the video. The user may pick one or more frames or images from the video as described in more detail below.

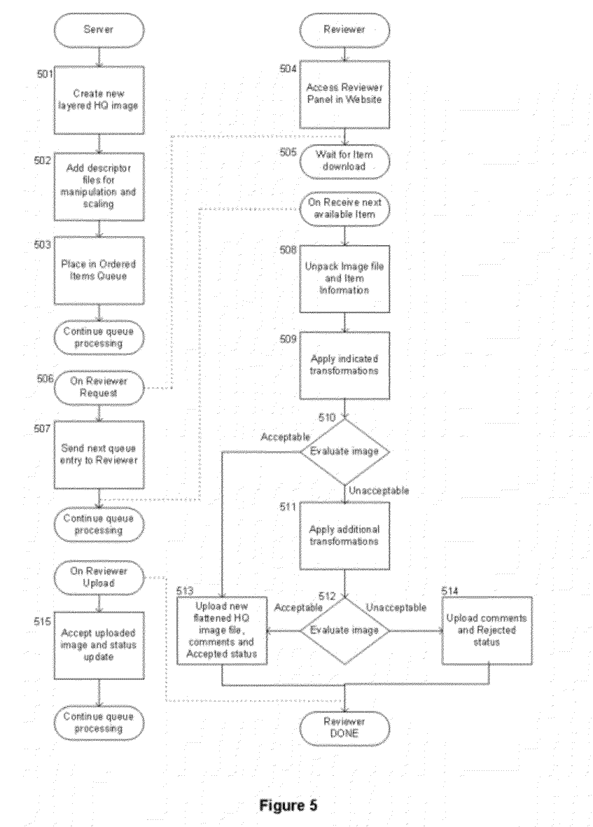

In one embodiment, the Video Player 110 may play LQ video files to allow the user to home in on, or pre-select, a small range of images. The user may select an image of interest 204. The Frame Browser 116 may then display the frames within a small range surrounding the selected image individually, allowing the user to select a specific frame or image from within that range 205. In one embodiment, the frames may be displayed as a cover flow, as shown in FIG. 5. Each frame within a range may be displayed sequentially. Alternatively, every second, or fifth, or tenth frame, for example, may be displayed. In one embodiment, when the user identifies a particular frame to be selected, the time index associated with the position of the particular frame within the LQ video file may be captured. The particular LQ frame itself is also captured by LQ Image Management 117. The user may decide to select additional frames from the video, or, if no additional frames are desired, continue to produce an image from the selected frame 206. In one embodiment, the user may also elect to share the selected frame via e-mail, social network sites, or other websites.

After LQ frames of interest have been identified, in one embodiment, the user may then execute Image Customization 118 to optionally select a template for formatting the image from a predefined set of templates 207. If the user elects to select a template 208, the user may customize properties of the selected template 209. The user may also customize and manipulate the LQ frames in various ways 210, including actions such as cropping, scaling, rotating, adding text or logo images, adjusting colors, applying effects, and placing one or more frames in the template. A record of the manipulations performed on each LQ frame is saved to a file available to the system for use in fulfillment and sharing.

Once the image has been customized to his satisfaction, the user may then specify options for fulfillment 211, defining the form of the desired finished product, by executing Order Definition 119. The product selected may range from a poster 212 or canvas print 213 in various sizes and formats, to products such as a t-shirt 214 or other product 216 displaying the finished image. Alternatively or additionally, the user may simply elect to share the image via e-mail or posting to a social network site or other website 215. After one or more products have been selected, the user may then be prompted to enter payment information, which may be made through e-commerce billed to a credit card. Payment information may be collected 217. In one embodiment, this information and the amount of the charge for the finished product may be passed by the E-Commerce Manager 114 to a third party e-commerce transaction processing company for validation and completion of the payment processing 218. Upon completion of payment processing, transaction status information may be passed back to the E-Commerce Manager 114, which may then approve the service requested. Upon completion of the payment transaction, the order may be submitted for generation.

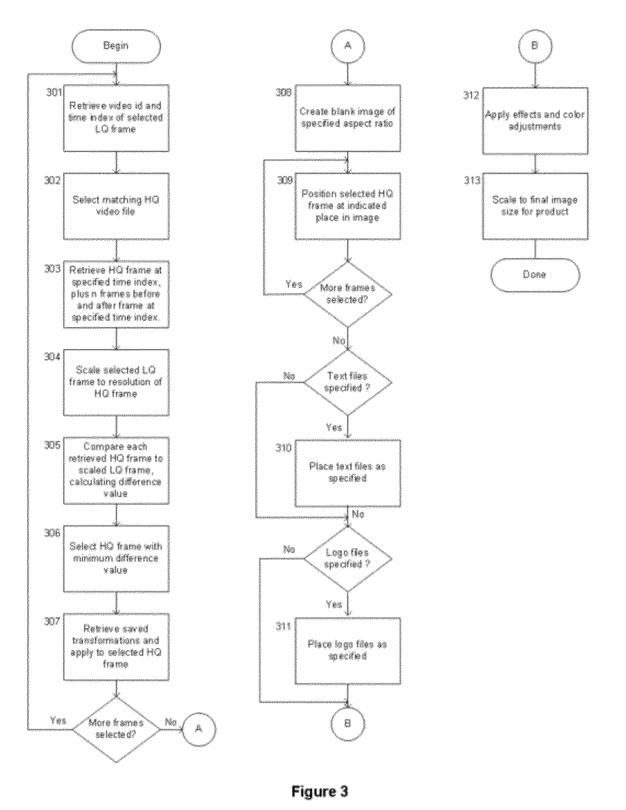

Once the user has completed the order process, the system may retrieve the HQ frame corresponding to each specific LQ frame from HQ video storage 219 through HQ Image Management 121. FIG. 3 shows one embodiment of the process of creating a high quality image based on the LQ image based on the captured frames. In one embodiment, the name of the LQ video file and the time index associated with the LQ frame may be retrieved 301. The LQ video file identifier may be used to identify the appropriate HQ video file 302. In one embodiment, the time index for the LQ frame selected may be used to retrieve the corresponding HQ frame from the matching HQ video file 303, along with a small range of neighboring frames. The number of neighboring frames may be chosen, for example, as the equivalent of approximately one second of video run time. The selected LQ frame may then be scaled to the resolution of the HQ frame 304. Pattern matching may then be used on the small set of HQ frames from an interval enclosing the identified HQ frame, comparing each of them with a scaled version of the selected LQ frame resized to the resolution of the HQ frames 305, in order to select the image with minimum difference 306, further ensuring that the precise selected HQ frame is correctly identified. In one embodiment, the HQ Image Customization 122 may then apply any indicated transformations, including such operations as cropping, rotating, resizing, color transformations, and other edits, to the identified HQ frame 307. This process may be repeated for each frame identified and incorporated into the final customized image. HQ Image Customization 122 may then create a blank image with the aspect ratio specified for the customized image 308 and position the proper portion of the edited identified HQ frame in the appropriate position in the customized image 309. Again, this process is repeated for each frame if multiple frames are incorporated into the final customized image. The HQ Image Customization module 122 may then add any specified text files 310 or logo files 311, apply any specified effects including color adjustment or artistic effects to the image to further customize it 312, and then scale the customized image to the proper size 313 to create the final customized HQ image.

In one embodiment, the LQ Image Customization 122 may then transform the final customized HQ image to LQ, and deliver the resulting LQ image to the user via the Web Site Interface 115. The Web Site Interface 115 may then display the image to the user so that the user may view it and further verify that it is the image the user wishes to select.

The system then may send the customized image along with necessary order information to the appropriate destination for fulfillment 221 using External Service Manager 113. After the user has completed specifying an order, the user may elect to continue browsing and shopping on the site or to exit the site 222.

User actions may also include functions such as saving work in progress and personal video uploads, as well as metatagging of segments or frames of video files for searching and general identification.

In another embodiment, in which the system is extended by the addition of an Image Reviewer Subsystem, the extracted HQ frames may be saved as separate layered images. Along with a file describing the manipulations to be performed for each image, any associated templates, and order identification information, the layered images may be losslessly compressed and placed in a queue for review by persons skilled in image manipulation. This set of files is referred to as an “item,” since it contains all the information necessary to complete the production of an item or product that has been ordered by a user. At least one human reviewer, a person skilled in the editing and evaluation of graphic images, may access the system via a client computer containing image editing software. The human reviewers may receive the item files and extract the individual layered images and the accompanying information describing the manipulations to be performed. The reviewers then may perform the indicated scaling and manipulation of the extracted frames. When they have completed the specified operations, they may evaluate the resulting image and determine whether further adjustments of color, focus, and other parameters are advisable. They may perform any additional adjustments. They then may place the finished image in a queue to be sent to the appropriate fulfillment agent.

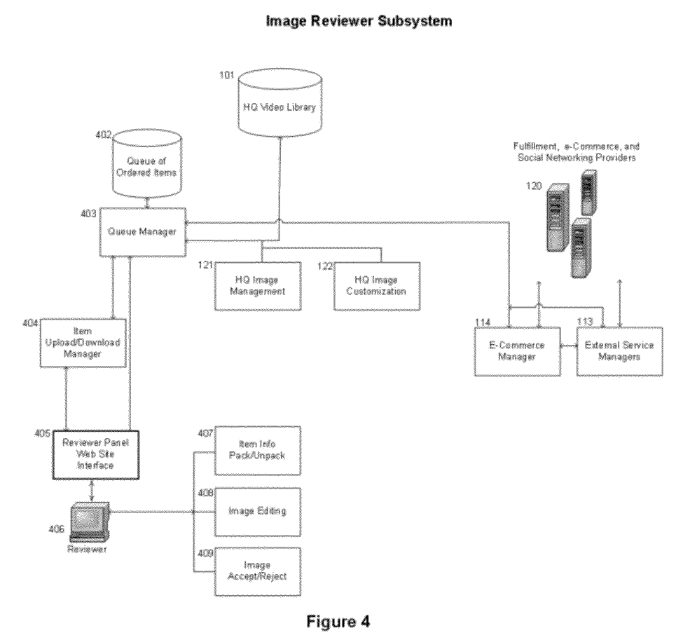

One embodiment of an Image Reviewer Subsystem is shown in FIG. 4. The Image Reviewer Subsystem comprises software executing on the server and third-party image editing software controlled by human Reviewers. The two parts of the system may communicate via asynchronous messaging. The HQ frame or frames may be extracted from the appropriate file or files in the HQ Video Library 101 by HQ Image Management Module 121 and, along with the accompanying file customization description and order identification information, may be placed by the Queue Manager 403 in the Queue of Ordered Items 402. At least one Reviewer 306 may access the system via the Reviewer Panel Web Site Interface 405. The Interface 405 may enable access via the Item Upload/Download Manager 404 to a folder for upload and download of files to the system. In one embodiment, the Reviewer 406 may download the next item that has not yet been reviewed from the Queue of Ordered Items 402. The Item Info Pack/Unpack module 407 may unpack the item into its constituent files. The Reviewer may then perform the indicated transformations on the image file using the Image Editing module 408, including any scaling of the image to the specified size for printing. After performing all specified transformations on the image file, the Reviewer 406 will generate a final image in an appropriate format for fulfillment, examine the resulting file, and evaluate its suitability for fulfillment. If the resulting file is deemed unsatisfactory, the Reviewer 406 may perform additional transformations to enhance the image quality, including adjustment of colors and shadows and blurring of pixelated areas in the image. When the image is deemed satisfactory, the Reviewer may generate the final image in an appropriate format for fulfillment and upload the final image to the Queue of Ordered Items with its status changed to “Accepted” via the Item Accept/Reject module 409. An Accepted Item is then made available via External Service Managers 113 to the appropriate fulfillment agent 120. The fulfillment agent may use the received image in producing the final product, such as a canvas print, poster, t-shirt, mug, or other article. If, because of limitations of quality of the originally uploaded video file and the requirements of the selected product, further manipulations by the Reviewer still do not result in a satisfactory image, the Reviewer may use the Image Accept/Reject Module 409 to notify the Queue Manager 403 that the item may be given the status Rejected, marking it for handling by Customer Service. When an image is accepted after enhancement or is rejected, the Reviewer may be prompted to add explanatory notes characterizing the problems and adjustments that were made. This information may be archived in a database to be analyzed for further image processing automation and for improvement of reviewer procedures.

The typical course of usage of the Image Reviewer Subsystem is shown in FIG. 5. After a user has selected and manipulated one or more frames to produce a custom image and ordered a product incorporating the custom image, the system on the server may use the HQ Image Management module to create a new layered HQ image 501. The server system may then add a file defining the manipulations applied to the video frame to produce the custom image, and a file specifying the characteristics of the product being ordered (such as size of image, whether product is wall art or apparel, finish for wall art, etc.) 502. The Queue Manager 403 then may place the Item in the Queue of Ordered Items ready to be reviewed 503.

The Reviewer logs in to the Reviewer Panel 504 (an administrative, controlled-access website that connects to the system with an interface that allows access to remote folders for download and upload of files). When the system recognizes that a Reviewer has logged in and indicated readiness to proceed 506, the system may send the next item in the queue to the Reviewer 507. The Reviewer may receive the next Item in the queue and unpack the HQ image file and associated information 508. The Reviewer may apply the transformations specified to the HQ image file, including any scaling and/or cropping specified 509. The Reviewer then may evaluate the resulting customized image 510, taking account of the product for which it is intended, and deciding whether the image is of acceptable quality.

If the Reviewer decides that the image quality is acceptable, he may generate the final image in an appropriate format for fulfillment and upload it to the server 513, along with a status update that the item has been Accepted (is ready for fulfillment). If the Reviewer believes that the image quality is not acceptable, he may apply additional transformations to the image 511. Such additional transformations may include, for example, adjusting color intensity or shadows, or blurring of areas in the image where pixelation is evident. After applying additional transformations, the Reviewer again evaluates the image 512, and may at this point determine that the image is now of acceptable quality, and may be generated in its final format and uploaded to the server 513, along with comments describing the problems and the techniques used to enhance the image. Alternatively, the Reviewer may determine that the image cannot be altered to acceptable quality even with expert intervention, in which case the Reviewer will upload notification to the server that the Item should be Rejected, along with comments describing the problems and the unsuccessful efforts to correct them 514. The Queue Manager, on recognizing that the Reviewer has sent an update of file status, may accept the uploaded image for an Accepted item, and may update the status of the item either to Accepted or to Rejected 515.

In an alternative embodiment, tiers of reviewers may be included, with varying levels of expertise, and decisions on item status changes may be limited to reviewers of higher expertise.

Those skilled in the art will understand and appreciate the existence of variations, combinations, and equivalents of the embodiments described herein which would not depart from the spirit and scope of the present invention. While the presently preferred embodiments have been described for the purpose of this disclosure, numerous changes and modifications will be apparent to those skilled in the art. The invention should therefore not be limited by the above described embodiment, method, and examples, but should include all embodiments and methods within the scope and spirit of the invention.

What is claimed is:

1. An internet-based system for sharing, selling, and producing products containing custom images comprising:
at least one server computer;
a communications link between said server computer and the Internet;
software for creating and maintaining a library of High Quality (HQ) video clips of any length, comprising files of compressed video data processed in ways that improve the ability to scroll through each said video clip, said library of processed HQ video clips accessible by said server computer;
software for creating and maintaining a library of Low Quality (LQ) video clips in a corresponding format to said files of HQ video clips, comprising files of compressed video data corresponding to said processed files of compressed HQ video data in said library of HQ video clips, and processed in a corresponding fashion, but with a lower resolution and a standard bitrate, to improve the ability to stream and scroll through each said video clip, said library of processed LQ video clips accessible by said server computer;
at least one client computing device for customer users;
a communications link between said client computing device for customer users and the Internet;
a web browser or application supporting online interaction on each of said client computing devices;
software executing on said server computer or through other server means for selecting and providing the play of said files of compressed video data from said library of LQ video clips to at least ore user;
a user interface for said at least one user implemented through said web browser or application supporting online interaction on said client computing device enabling the selection, display and control of said files of compressed video data from said library of LQ video clips, and enabling the selection and identification of at least one particular frame from at least one of said selected files of compressed video;
a user interface for said at least one user implemented through said web browser or application supporting online interaction on said client computing device enabling the sharing of said particular frame from at least one of said selected files via e-mail or hosting or posting to a website;
a user interface implemented through said web browser or application supporting online interaction on said client computing device enabling the manipulation and editing of at least one of said selected particular frames to create a custom image, the optional sharing of said custom image from at least one of said selected files via e-mail or hosting or posting to a website, the optional creation of an order for at least one product incorporating said final image; the collection of payment and shipping information relating to said order for said product;
software executing on said server computer for managing images for orders along with order and image status information;
software executing on said server computer for communicating with an appropriate payment processor to provide necessary payment information and receive sale completion status;
software executing on said server computer for identifying an appropriate fulfillment agent, providing to said fulfillment agent the necessary information for order fulfillment, and receiving from said fulfillment agent status information on order creation and shipping.

2. The system according to claim 1, wherein
said software for creating and maintaining said library of LQ video clips also preserves any existing audio component from said HQ video clips, and
said user interface implemented through said web browser or application supporting online interaction on said client computing device enables the play and control of any of said associated and concurrent existing audio components as said LQ video clips are displayed.

3. The system according to claim 1, wherein said software executing on said server computer for managing images for orders includes assigning said images to a reviewer, and further comprising:
at least one client computer for said reviewers;
a communications link between said client computer for said reviewers and the internet; and
software for said reviewers for
receiving files defining said images, including HQ frames corresponding to the LQ frames from which said images were created and information describing the manipulations performed to create said images;
scaling, manipulating, and editing said HQ frames; and
either producing a final image for incorporation into a product and uploading it to said server computer with status indicating an order associated with said image is ready to be fulfilled, or enabling a decision that said final image is not of acceptable quality, and uploading to said server computer status information indicating said image is of unacceptable quality.

4. An internet-based system for creating a high-resolution image comprising:
at least one server computer;
a communications link between said server computer and the Internet;
software for creating and maintaining a library of High Quality (HQ) video clips of any length, comprising files of compressed video data processed in ways that improve the ability to scroll through each said video clip, said library of processed HQ video clips accessible by said server computer;
software for creating and maintaining a library of Low Quality (LQ) video clips in a corresponding format to said files of HQ video clips, comprising files of compressed video data corresponding to said processed files of compressed HQ video data in said library of HQ video clips, and processed in a corresponding fashion, but with a lower resolution and a standard bitrate, to improve the ability to stream and scroll through each said video clip, said library of processed LQ video clips accessible by said server computer;
a client computing device;
a communications link between said client computing device and the Internet;
a web browser or application supporting online interaction on said client computing device;
software executing on said server computer or through other server means for selecting and providing the play of said files of compressed video data from said library of LQ video clips;
a user interface implemented through said web browser or application supporting online interaction on said client computing device enabling the selection, display, and control of said files of compressed video data from said library of LQ video clips, and enabling the selection and identification of at least one particular LQ frame from at least one of said selected files of compressed video data and of the time index at which each said selected and identified particular LQ video frame appears;
software executing on said server computer for selecting from the library of HQ video clips the HQ video clip file corresponding to the LQ video clip file from which each of said LQ frames was selected and identified, and for selecting and identifying the particular frame from the corresponding HQ video clip that most closely matches each of said selected and identified LQ frames.

5. The system according to claim 4, wherein
said software for creating and maintaining said library of LQ video clips also preserves any existing audio component from said HQ video clips, and
said user interface implemented through said web browser or application supporting online interaction on said client computing device enables the play and control of any of said associated and concurrent existing audio components as said LQ video clips are displayed.

6. The system according to claim 4, wherein
said library of LQ video clips comprises files of compressed LQ video data created from said files of compressed HQ video data, with identical frame rate, file format, and duration, but with a lower resolution and a standard bitrate.

7. The system according to claim 4, wherein
said user interface implemented through said web browser or application supporting online interaction on said client computing device enabling the selection, display and control of said files of compressed video data from said library of LQ video clips, and enabling the selection and identification of at least one particular LQ frame from at least one of said selected files of compressed video data also enables the identification and acquisition of the time index associated with each said selected and identified particular LQ video frame.

8. The system according to claim 7, wherein
said software executing on said server computer for selecting from the library of HQ video clips the HQ video clip file corresponding to the LQ video clip file from which each of said LQ frames was selected and identified, selects and identifies a neighborhood of HQ frames with the same time index as said time index of said selected and identified LQ frame, and selects from said neighborhood of HQ frames the particular HQ frame that most closely matches said selected and identified LQ frame.

9. A method for sharing, selling , and producing products containing custom images, the method comprising:
providing a library of High Quality (HQ) video clips of any length, comprising files of compressed video data processed in ways that improve the ability to scroll through each said video clip, said library of processed HQ video clips accessible by a server computer;
providing a library of Low Quality (LQ) video clips in a corresponding format to said files of HQ video clips, comprising files of compressed video data corresponding to said processed files of compressed HQ video data in said library of HQ video clips, and processed in a corresponding fashion, but with a lower resolution, to improve the ability to stream and scroll through each said video clip, said library of processed LQ video clips accessible by said server computer;
providing software executing on said server computer or through other server means for selecting and providing the play of said files of compressed video data from said library of LQ video clips to at least one customer user;
selecting, display and control by said at least one customer user of a set of said files of compressed video data from said library of LQ video clips,
selecting and identifying by said at least one customer user of at least one particular frame from at least one of said selected files of compressed video;
sharing by said at least one customer user of said particular frame from at least one of said selected files via e-mail or hosting or posting to a website;
manipulating and editing by said at least one customer user of at least one of said selected particular frames to create a custom image,
sharing by said at least one customer user of said custom image via e-mail or hosting or posting to a website;
creating an order by said at least one customer user for at least one product incorporating said custom image;
collecting from said at least one customer user payment and shipping information relating to said order for said product;
managing images for orders along with order and image status information;
communicating with an appropriate payment processor to provide necessary payment information and receive sale completion status;
identifying an appropriate fulfillment agent for said product, providing to said fulfillment agent the necessary information for order fulfillment, and receiving from said fulfillment agent status information on order creation and shipping.

10. A method for creating a high-resolution image from a video clip, the method comprising:
providing a library of High Quality (HQ) video clips of any length, comprising files of compressed video data processed in ways that improve the ability to scroll through each of said video clips, said library of processed HQ video clips accessible by a server computer;
providing a library of Low Quality (LQ) video clips in a corresponding format to that of said HQ video clips, comprising files of compressed video data corresponding to said processed files of compressed HQ video data in said library of HQ video clips, and processed in a corresponding fashion, but with a lower resolution and a standard bitrate, to improve the ability to play and scroll through each said video clip, said library of processed LQ video clips accessible by said server computer;
providing software executing on said server computer or through other server means for selecting and providing the play of said files of compressed video data from said library of LQ video clips via the internet;
selecting, display, and control by a customer user of said files of compressed video data from said library of LQ video clips;
selecting and identification by said customer user of at least one particular LQ frame from at least one of said selected files of compressed video data and of the time index at which each said selected and identified particular LQ video frame appears;
selecting from the library of HQ video clips the HQ video clip file corresponding to the LQ video clip file from which each of said LQ frames was selected and identified; and
selecting and identifying the particular HQ frame that most closely matches each of said selected and identified particular LQ frames by using said time index to retrieve a number of HQ frames from said corresponding HQ video clip file in a neighborhood surrounding said time index and by comparing each of said retrieved HQ frames to each of said corresponding selected and identified particular LQ frame, scaled to match the size of the HQ frames, to find each HQ frame with minimum difference from each of said particular LQ frames.
